(19) United States
(12) Patent Application Publication
(10) Pub. No.: US 2012/0291373 A1
(43) Pub. Date: Nov. 22, 2012

(54) Energy Saving Materials and Methods

(76) Inventors: Sabin Ewing, Smyrna, TN (US); Ryan Carney, Goodlettsville, TN (US); Brendan Babcock, Columbia, TN (US)

(21) Appl. No.: 13/473,564

(22) Filed: May 16, 2012

Related U.S. Application Data
(60) Provisional application No. 61/519,042, filed on May 16, 2011.

(51) Int. Cl. E04D 1/22; C08L 95/00; E04B 1/80; B32B 5/16

(52) U.S. Cl. 52/173.1; 428/143; 428/411.1; 428/142; 428/144; 252/586; 52/741.4

(57) ABSTRACT

A shingle has a color changing outer surface. The color changing outer surface can have a first color under a first environmental condition and a second color under a second environmental condition. The color changing outer surface is capable of both changing from the first color to the second color and from the second color to the first color. Methods using the shingles for reducing energy absorption and for producing an image or pattern are also disclosed.

### CROSS-REFERENCE TO RELATED APPLICATIONS

This application claims priority to provisional application 61/519,042 filed May 16, 2012.

### STATEMENT REGARDING FEDERALLY SPONSORED RESEARCH

Not Applicable

### FIELD OF THE INVENTION

This invention relates to a roof or surface that changes hue when exposed to varying temperatures and/or light intensities.

### BACKGROUND OF THE INVENTION

A traditional building's roof is often exposed to more sunlight than any other portion of the building. In cooler climates or during the winter months this exposure to sunlight may be considered beneficial as the solar energy absorbed by a roof can provide some amount of desired heating to the building. More often than not this desirable heating during colder months is outweighed by the undesirable heating that occurs in the summer months when the sun's rays are more intense and are extant over a longer portion of a 24 hr period than in the cooler months. The energy costs to cool down buildings could be greatly lessened in some instances if the heat generated by a dark roof during the warmer months could be diminished. A roof that changes from a darker hue/color in cooler weather to a lighter hue/color in warmer weather would be desirable in that a darker roof in cooler weather could increase the temperature of the structure, thus lowering energy costs. Energy conservation is of great importance as it reduces the amount of fossil fuels used and lessens dependence on imported oil while at the same time lowering energy costs. There is a need for a roof that lowers energy usage and costs as the seasons change.

U.S. Pat. Nos. 5,558,700 and 5,919,404 provide some color changing materials that may be used within various embodiments of the invention. These materials can be added to resins (e.g. thermoplastics or PVC) that are then molded into various different designs or sheeting. U.S. Pat. No. 4,826,550 describes aspects of this. There are many different colors that can be produced. U.S. Pat. No. 5,919,404 describes a method for creating reversible thermochromic compositions that exhibit a wide range of traditional colors, while U.S. Pat. No. 5,558,700 describes a method for creating reversible thermochromic compositions that exhibit fluorescent colors. It is likewise known that thermochromic compositions can be laminated to various substrates depending on the desired application, i.e. U.S. Pat. No. 5,352,649 pertaining to a thermochromic laminate member, and composition and sheet for producing the same; U.S. Pat. No. 5,688,592 (“Shibahashi '592”); and U.S. Pat. No. 5,585,425. These patents are incorporated herein by reference.

U.S. Pat. Nos. 4,028,118 and 5,585,425 and 5,919,404 provide methods for providing different and/or customized properties of the thermochromic material. These patents are incorporated herein by reference.

Thermochromic compositions can be produced in the form of microcapsules using conventionally known methods to protect the material from external elements, maintain their functionality and to endow them with desirable properties and characteristics. U.S. Pat. Nos. 4,028,118 and 5,919,404 are good examples of patents that describe known properties of thermochromic compositions.

Thermochromic laminates as described in U.S. Pat. No. 6,500,555 are incorporated into this application. U.S. Pat. No. 7,335,419 describes some thermochromic materials as well as their structure and/or their structure as temperature or light changes occur. Both of these patents are incorporated by reference in their entirety.

Some methods for coating substrates are contained within US 2004/0121071. Colorchanging systems and surface coverings are also contained within US 2008/0209825 and US 2010/0225988. These three patents are incorporated by reference in their entirety.

The instant invention as disclosed within this application, provides a roof system that fills this need. The art referred to and/or described within this application is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Unless stated otherwise whenever the terms shingle, panel, roof, or similar words are used, it should be understood that the term can apply to all surfaces that can include a color changing (e.g. thermochromic) material. These terms listed can ordinarily be used interchangeably unless stated otherwise or when used in the same sentence or passage in combination with one another. Also, these color changing materials are not to be confined to roofs as siding can also benefit from a color changing surface.

Finally, in as much as color changing material can be activated by changes in temperature, light or radiative intensity, or wavelength, or any combination of these, when used in this application any of these color changing triggers are considered in the place of the trigger expressly stated.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment of the invention, a roof comprises shingles of asphalt construction and having a color changing outer surface. Of course other roofing or siding materials can have color changing qualities. The color changing outer surface can have a first color under a first environmental condition and a second color under a second environmental condition. The color changing outer surface can be capable of both changing from the first color to the second color and from the second color to the first color.

In at least one embodiment, the color changing outer surface includes (a) one or more electron-donating, chromatic organic compounds selected from the group consisting of diaryl phthalides, aryl phthalides, indolylphthalides, polyarylcarbinols, leucoauramines, acrylauramines, arylauramines, rhodamine B lactams, indolines, spiropyrans, fluorans, thiofluorans, phenothiazines, triphenylmethanes, diarylarylfurans, spiroxanthenearylfurans, and chromenoindoles, (b) one or more compounds capable of reversibly accepting electrons of said organic compound selected from the group consisting of phenolic hydroxy group-containing compounds and derivatives thereof and carboxyl group-containing compounds and derivatives thereof, (c) one or more compounds controlling the temperature and sensitivity of coloration/decoloration of said thermochromic material selected from the group consisting of alcohols, esters, ketones, esters, acid amides and carboxylic acids, the ratio of each component to others (a):(b):(c) being 1:0.1 to 10:1 to 100 by weight, and (d) one or more radical cationic compounds selected from the group consisting of N-radical cationic, P-radical cationic, O-radical cationic and S-radical cationic compounds having aromatic ring(s), in an amount of from 0.01 to 5 parts by weight per 1 part by weight of said electron-donating chromatic organic compound, said radical cationic compound interacting with said electron-donating, chromatic organic compound to stabilize said compound, resulting in a thermochromic material with an improved resistance to light.

In at least one embodiment, the color changing outer surface comprises asphalt. In at least one embodiment, a transparent layer is disposed over the outer surface. In at least one embodiment, a roof comprises shingles having a color changing outer surface with a first color under a first environmental condition and a second color under a second environmental condition. The color changing outer surface is capable of both changing from the first color to the second color and from the second color to the first color. The shingles can be selected from the group consisting of asphalt, wood, metal, and/or concrete. Metal roofs or shingles are often steel, tin, aluminum, and/or copper. Metal roofs or siding can have the thermochromic material added to paints or other coatings with rust inhibitors that allow the thermochromic coating to be applied to the metal directly. Direct to metal top-coats having thermochromatic material can provide excellent weather and corrosive protection, bonding, hide and coverage, and can be applied directly to metal roofing or siding. Other applications may be heavy equipment, railing, skids, pipes, cranes, tanks, oilfield machinery, trucks, tractors, etc. without the use of a primer. One direct to metal coating that can be used is developed and manufactured by Coastline Industrial Coatings. This product is called IF-173 DTM and is available in many colors.

In at least one embodiment, the first environmental condition and the second environmental condition are selected from the group consisting of temperature, light intensity, wavelength of light, wavelength of radiation, and any combination thereof.

In at least one embodiment, the color changing outer surface is covered by a layer of transparent material.

In at least one embodiment, the outer surface comprises a thermochromic coating. In at least one embodiment, the outer layer is a laminate comprising thermochromic material.

In at least one embodiment, the transition from the first color to the second color occurs at a threshold temperature. In at least one embodiment, a gradual transition from the first color to the second color occurs with a rise in temperature.

In at least one embodiment, the outer surface of shingles of asphalt, wood, metal, and/or concrete comprises discrete particles comprising (a) one or more electron-donating, chromatic organic compounds selected from the group consisting of diaryl phthalides, aryl phthalides, indolylphthalides, polyarylcarbinols, leucoauramines, acrylauramines, arylauramines, rhodamine B lactams, indolines, spiropyrans, fluorans, thiofluorans, phenothiazines, triphenylmethanes, diarylarylfurans, spiroxanthenearylfurans, and chromenoindoles, (b) one or more compounds capable of reversibly accepting electrons of said organic compound selected from the group consisting of phenolic hydroxy group-containing compounds and derivatives thereof and carboxyl group-containing compounds and derivatives thereof, (c) one or more compounds controlling the temperature and sensitivity of coloration/decoloration of said thermochromic material selected from the group consisting of alcohols, esters, ketones, esters, acid amides and carboxylic acids, the ratio of each component to others (a):(b):(c) being 1:0.1 to 10:1 to 100 by weight, and (d) one or more radical cationic compounds selected from the group consisting of N-radical cationic, P-radical cationic, O-radical cationic and S-radical cationic compounds having aromatic ring(s), in an amount of from 0.01 to 5 parts by weight per 1 part by weight of said electron-donating chromatic organic compound, said radical cationic compound interacting with said electron-donating, chromatic organic compound to stabilize said compound, resulting in a thermochromic material with an improved resistance to light. The discrete particles can be granules or other small materials disposed on a shingle.

In at least one embodiment, the roof has roof panels that have an outer surface as described in the previous paragraph directly disposed thereon.

In at least one embodiment, a roof panel comprises particles having a color changing outer surface with a first color under a first environmental condition and a second color under a second environmental condition. The color changing outer surface is capable of both changing from the first color to the second color and from the second color to the first color. These particles can be glass, a metal oxide, or can be asphalt as used in asphalt shingles.

In at least one embodiment, the particles themselves are thermochromic materials or are individually coated with thermochromic materials. In some embodiments the particles on a shingle have different color changing qualities such that some of the particles change color at a particular temperature, light intensity, or wavelength while other particles require a higher temperature, greater light intensity, or different wavelengths to transition to a new color. Some of the particles on a panel or applied directly to the roof substrate do not have color changing qualities while other particles do. In some embodiments these color changing particles have different color changing properties. This allows for customizing the aesthetics of a roof. Shading patterns and other design patterns can be formed in this manner

In at least one embodiment, the outer surface of the particles comprises a coating, the coating selected from the group consisting of powder coatings, paint, polymer, and any combination thereof

In at least one embodiment, the coating comprises a powder coating selected from the material group consisting of epoxies, polyesters, urethanes, nylon, vinyl, polyethylene, and any combination thereof.

In at least one embodiment, the outer surface coating is of uniform construction.

In at least one embodiment, at least one portion of the roof or a panel maintains the substantially same color under the first environmental condition and the second environmental condition while another portion transitions from one color to another. It should be noted that throughout this application white and black are considered as colors.

In at least one embodiment of the invention, a roof comprises an outer surface having a first color under a first environmental condition and a second color under a second environmental condition. The outer surface can have the capability of both changing from the first color to the second color and from the second color to the first color.

In at least one embodiment, the first environmental condition is selected from the group consisting of temperature, light level, wavelength of light, and any combination thereof.

In at least one embodiment, the second environmental condition is selected from the group consisting of temperature, light level, and any combination thereof.

In at least one embodiment, the outer surface comprises a thermochromic paint.

In at least one embodiment, the outer layer is a laminate comprising thermochromic material.

In at least one embodiment the first color is substantially darker than the second color (darker here assumes the same radiative/light source at the same intensity on both colors). As an example, a first color is extant in cooler temperatures of between about −120 and 65 degrees Fahrenheit, and the second color is extant in warmer temperatures of between about 65 and 150. The darker color here can also include the color that absorbs more energy from the radiative source to which the surface is exposed. Thus, for example, a monochromatic light source striking a surface having that very same monochromatic color will absorb more energy than a deeper hue of another color that is not. Thus, in some embodiments at a certain temperature/radiative intensity a roof can change color to even a deeper hue of a different color in order to lessen the heating of a surface. While this would not generally be the case when exposed to sunlight; in environments where a certain color of light is used in a particular application it can be desirable

In at least one embodiment, the roof transitions abruptly from a first color to a second color at a threshold temperature.

In at least one embodiment, the roof gradually transitions from the first color to the second color with a rise in temperature.

In at least one embodiment, the outer surface is disposed on a membrane disposed on the roof panels.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is top view of a representative embodiment of the invention.

FIGS. 2a-2c are side cross-sectional views of an embodied roof.

FIG. 3 is a perspective view of a single granule that can be used in asphalt roofing

FIG. 4 is a perspective view of a roof panel having a pattern formed by a differing granules.

FIG. 5 is a top view of a roof

FIG. 6 is a top view of a roof

FIG. 7 is cross-sectional view of a roof having a specific color changing viewing angle.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. It should be noted that the terms “cooler temperature” and “warmer temperature” are relative. For example, in some embodiments the warmer temperature may be 32 degrees Fahrenheit while in other embodiments the cooler temperature may be 65 degrees Fahrenheit. Generally, cooler temperatures may be between about −130 and 100 degrees Fahrenheit and warmer temperatures may be between 10 and 200 degrees Fahrenheit. These ranges are given primarily with regard to possible outdoor temperatures and roof temperatures. In other embodied applications of this invention the ranges may be substantially colder than the cool temperatures given and/or substantially hotter than the warm temperatures given. Given the same environment and a color transition that occurs due to a change in temperature, the term “cooler temperature” is associated with a temperature cooler than that associated with the term “warmer temperature”.

It should be noted that the terms “lesser light intensity” and “greater light intensity” are relative to one another. For example, in some embodiments the greater light intensity on the surface may be 1.5 kW/m² or greater particularly if the surface is in manufactured light while the lesser light intensity is less than this. In other embodiments the greater light intensity on the surface may be 0.75 kW/m² or greater; or 0.25 kW/m² or greater. The lesser light intensity being less than the greater light intensity in each embodiment and moving from the lesser light intensity to the greater light intensity results in a change in surface coloration. Throughout the application the term thermochromic should be recognized to mean having a color at one temperature that is different than the color at a different temperature. Unless heat and light intensity are distinguished between, thermochromic is also meant to include the meaning of having a color when exposed to one light intensity that is different than the color at a different light intensity. In some embodiments there are multiple color changes depending on the characteristics of the thermochromic properties of the surface with regard to temperature or light intensity. It should be noted that in other embodiments the greater light intensity can be between 1.5 and 10 kW/m². In some embodiments between about 10 and 100 kW/m²; and in other embodiments between about 100 and 1000 kW/m².

In some embodiments it is desirable that the roof remain a darker hue in warm temperatures such as on a cloudy day. In such an embodiment, the light from the sun is not strongly reaching the roof thus the roof is not heating up. For aesthetic reasons or for some other reason it can be desirable for the roof to remain darker. Thus in some embodiments, the light intensity must also reach a threshold intensity before the roof changes color. And in some embodiments the light intensity alone creates a change of surface coloration.

For the purposes of this disclosure, like reference numerals in the figures shall refer to like features unless otherwise indicated.

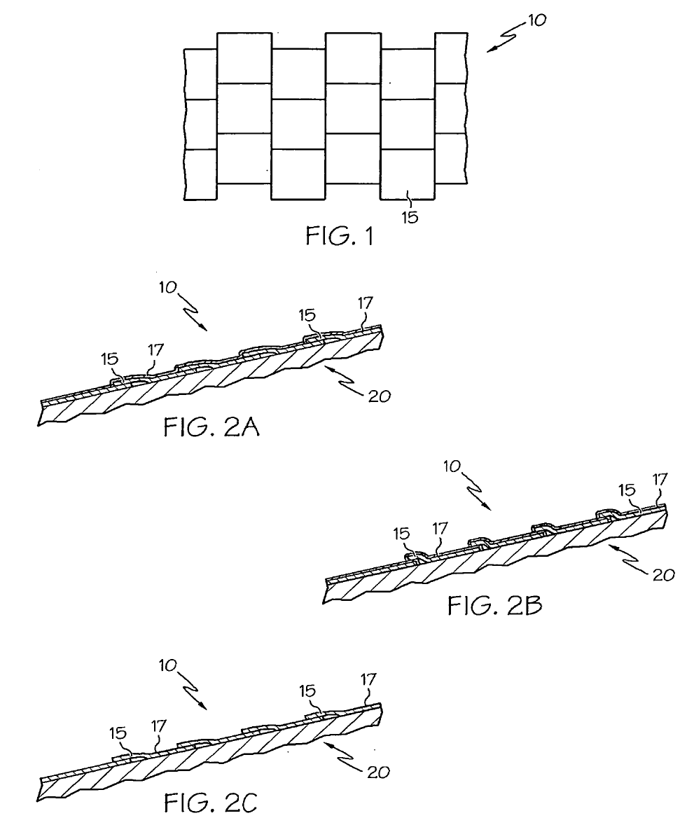

In FIG. 1 a top view portion of a representative roof 10 is shown. In this figure the roof has shingles 15. The shingles 15 can be made entirely of a thermochromic material. In other embodiments the thermochromic material is applied to the shingles or is a layer on the shingle.

In FIG. 2a the thermochromic material is applied to multiple shingles 15 as a coating 17 that extends over multiple shingles 15. Here the shingles are disposed on a roof substrate 20. The coating 17 could be applied after the construction of the shingles 15 and/or after they are applied to the roof substrate 20. In some embodiments the shingles are themselves the substrate. The coating can be a fluid (e.g. paint), membrane, powder, prefabricated/postfabricated cover, or any combination thereof that is applied to the shingles 15. The shingles can be of any size that would be appropriate for roof construction. The length and/or width of the shingles can range from less than 4 inches to more than 100 ft. In some embodiments the shingles 15 are fabricated as a sheet comprising multiple shingles per sheet. In some embodiments the sheet has an actual overlapping of shingles wherein the shingles are bound together to form the sheet. In some embodiments the sheet is made to appear as if it comprises multiple shingles wherein it is actually of single piece construction; in some embodiments sheets made to appear as if they comprise multiple shingles are formed together.

In some embodiments as in FIG. 2b, each of the shingles 15 has its own thermochromic coating 17. The coating can be a fluid (e.g. paint), membrane, powder or any combination thereof that is applied to each of the shingles 15. The sizing of these shingles 15 can be as those in the paragraph above.

The coating 17 can be applied to roof systems including those of asphalt, metal, rubber, membrane, slate, tile, stone, and/or plastic.

In FIG. 2c the thermochromic material 17 is part of the shingle 15 itself. In this embodiment the thermochromic coating is not applied to a shingle, but rather it is a part of the shingle composition itself. The thermochromic material 17 can have a greater concentration on the exposed side of the shingle 15 than on the portion contacting the substrate 20.

Though the roof 10 in FIGS. 2a-2c illustrate the overlapping of shingles 15, this overlap is not necessary. In some embodiments the roof has no overlapping shingles 15. Moisture and/or sunlight passing into possible cracks between shingles can be reduced by the sealing of the cracks between shingles 15 or by sizing the shingles such that the cracks are minimalized, or by sizing the shingles as one piece of shingle covers the entire roof or at least a portion extending from the top of the roof to the bottom of the roof. In instances where the roof is substantially flat an overlap need not exist though in some embodiments an overlap does exist. The roof 10 can have a base/substrate 20 of one piece construction.

The thermochromic coating 17 can also act to seal the roof as well. In some embodiments the thermochromic material is added to a sealant or paint to form a continuous roof surface that seals cracks or spaces in the substrate 20.

Dyes, paints, and/or inks having liquid crystals that are microencapsulated in the form of a suspension can be used as a part of the thermochromic surface and/or the thermochromic material of the shingles. After absorbing a certain amount of light or heat, the crystallic or molecular structure of the pigment can reversibly change in such a way that it absorbs and emits light at a different wavelength than at lower temperatures. This change in color can result from selective reflection of certain wavelengths by the crystallic structure of the material, as it changes between the low-temperature crystallic phase, through anisotropic chiral or twisted nematic phase, to the high-temperature isotropic liquid phase.

During the twisted nematic phase the molecules can orient in layers with regularly changing orientation, which gives them periodic spacing. The light passing the crystal can undergo Bragg diffraction on these layers, and the wavelength with the greatest constructive interference can be reflected back, which is perceived as a spectral color. A change in the crystal temperature can result in a change of spacing between the layers and therefore in the reflected wavelength. The color of the thermochromic liquid crystal can therefore continuously range from non-reflective (black) through the spectral colors to black again, depending on the temperature. Though multiple liquid crystals can be used two examples are cholesteryl nonanoate and cyanobiphenyls.

After absorbing a certain amount of light or heat, the crystallic or molecular structure of the pigment reversibly changes in such a way that it absorbs and emits light at a different wavelength than at lower temperatures.

It should be noted that the surfaces within this application can be either interior or exterior. In cooler temperature a darker interior floor may be desirable as solar energy can heat the floor as well as reduce glare. In warmer temperature a lighter interior floor may be desirable. Interior surfaces having exposure to the suns rays or artificial lighting may also benefit from a surface that changes color due to temperature.

These energy saving roofs can also be formed on vehicles such as mobile homes, pop-up trailers, trucks, tractors, golf carts, and cars. This can be done in a similar way as with the more stationary roofs for buildings. The thermochromic material can be applied after general construction as a paint or the like. The thermochromic material can also be constructed on the vehicle when manufactured. This thermochromic material can also be used in tents, tarps and the like. Among other uses, this could be helpful on the farm or while camping. The materials can also be applied after initial manufacture.

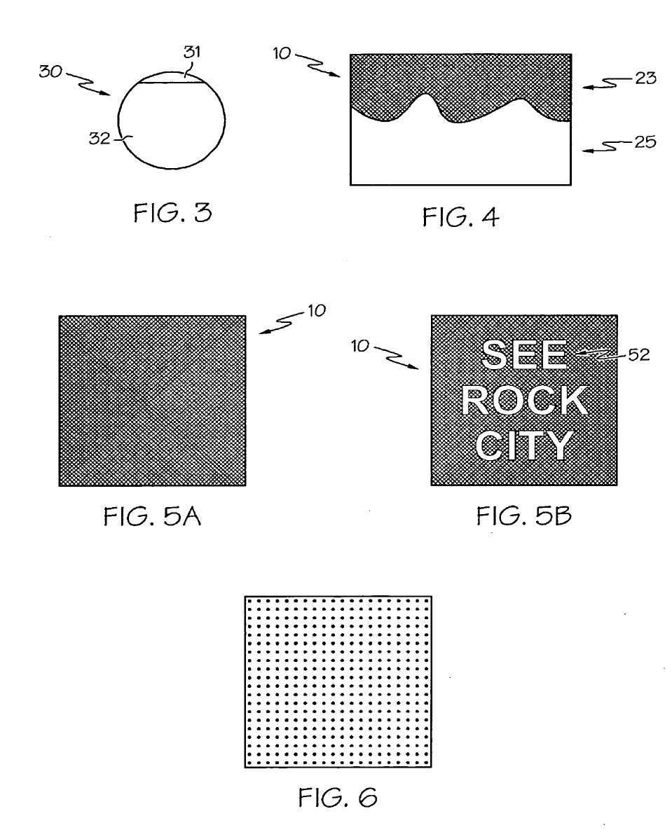

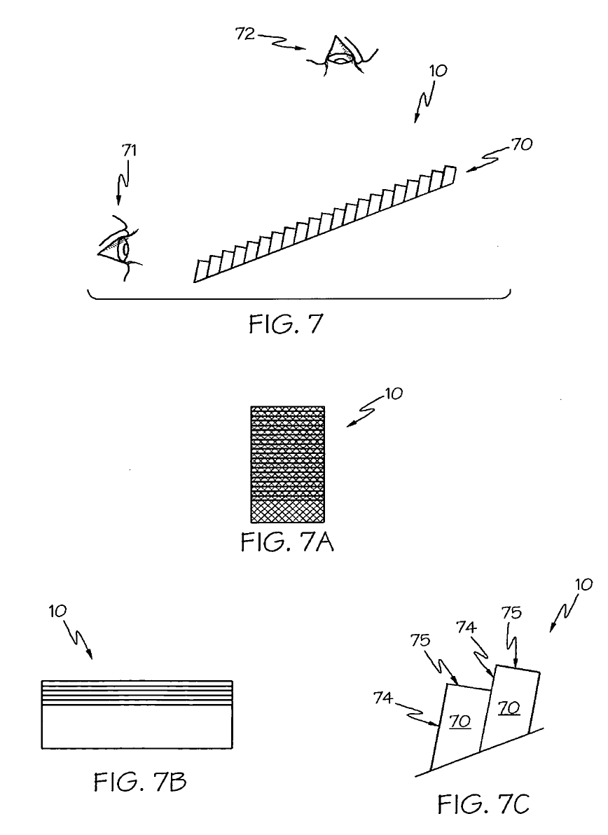

In some embodiments the thermochromic material is contained in discrete particles 30 as shown FIG. 3. These discrete particles can be manufactured components of the shingle or panel. In some embodiments, the thermochromic material comprises a coating 31 on the outer surface of each particle while in other embodiments, the discrete particles themselves comprise the thermochromic material. In such embodiments, individual batches of discrete particles comprising the thermochromic material can be manufactured and then can be incorporated into the shingle or panel using a variety of manufacturing methods. Some of these methods include using particles that are thermochromic only on a top portion 31 and 75 such that the color change is primarily observable from a downward view (see FIGS. 3 and 7). The non-thermochromic portions 32 and 74 do not change with temperature or light intensity. In other embodiments, the entire particle 30 is thermochromic.

Different batches of discrete particles can be prepared using different thermochromic materials such that the transition temperature or the transition light intensity is different on some portions on the shingle or panel than on other portions. An example of these batches in use is illustrated in FIG. 4 where color changing particles are used in section 25 of a roof panel 10 and different particles are used in section 23. The particles of section 23 can be either non-color changing or color changing at a different transition temperature or light intensity. FIG. 4 should be viewed as a snapshot in time, as the conditions change the coloring of the panel 10. As temperatures decrease for example, the panel 10 can become darker and as they increase the panel can have a larger portion that has transitioned in color.

For example, the temperature necessary to create a transition is 85° F. for one portion 25 of the panel and 95° F. for another portion 23 of the panel. As shown this may appear to be strictly delineated but in fact the transitions can occur at multiple points throughout the panel 10. Of course in some embodiments the transition is strictly delineated. Additional transition temperatures can also be extant on the panel such that a transition also occurs at 115° F., at 150° F., and at 180° F. for example. In some embodiments when these different portions are in the millimeter size range dispersed throughout a panel of the roof such that, for example only, a transition would change a black roof to charcoal gray, to gray, to off white, to white. Different colors can be used the same way such that a roof consisting of blue and yellow portions and appears green can transition to first a blue roof as the yellow portions turn white, for example. The blue roof can then turn to a white roof when the next transition characteristic is extant.

FIG. 4 and any other patterns, images, or alpha-numeric markings that can form from a color-changing trigger are applicable to any of the roofing material disclosed in this application including metal, concrete, stone, ceramic, wood, rubber, plastic, elastomer, asphalt, and any combination thereof.

The different portions on a shingle can be as big as a panel or smaller than a millimeter across. Some embodied panels are pixelated as illustrated in FIG. 6 such that tiny portions of the panel change at one temperature and/or light intensity amidst other tiny portions that may change at a different temperature and/or light intensity. Pixelated refers to surfaces that have small separated portions akin to many dots. A pixelated surface close up may look like a lot of dots or bits, but from a distance blend into an image or color. For example, from a distance a pixelated surface may appear green when upon closer inspection it consists of tightly spaced blue and yellow dots. This embodiment might appear to change a red roof to pink after the first transition where pixelated portions having a lower temperature transition turn white leaving higher transition pixelated portions unchanged. Upon reaching a higher temperature the roof may then turn to white after the second transition. Of course, any number of colors can be used. Additionally, many different transitions can occur at different temperatures or light intensity on a single panel. A template can be used for applying the thermochromic material in a pixelated. Computer graphic programs are capable of formulating a desired design or image.

In some embodiments, mixtures of particles from different batches can be incorporated into the shingle or panel. In at least one embodiment, all the discrete particles on the shingle or panel comprise the same thermochromic material. In other embodiments, the shingle or panel comprises a mixture of discrete particles comprising a thermochromic material and discrete particles that do not contain a thermochromic material. Such embodiments can be useful in creating a desired image or pattern on the structure when the structure is exposed to light.

In other embodiments the thermochromic material can be applied to a portion of the shingle or panel in a defined pattern in order to reveal a desired image (e.g. lettering, a scene) when the shingle or panel is exposed to light or heat above a designed transition point or in some instances when below a transition point. In FIG. 5a, for example, a roof or panel 10 has a standard look at a lower temp or light intensity and then displays a message 52 as shown in FIG. 5b when a transition characteristic is extant. In some embodiments a mixture of thermochromic materials can be applied to a portion of the panels or shingles. In at least one embodiment, some portions of the shingle or panel do not contain any thermochromic material.

In other embodiments, panels or shingles themselves can be arranged on the structure in a defined pattern to reveal a desired image on the structure when the structure is exposed to sunlight. In some embodiments, the shingles or panels each comprise different mixtures of thermochromic materials. In at least one embodiment, each shingle or panel comprises only one type of thermochromic material. In at least one embodiment, the pattern comprises shingles or panels with one or more thermochromic materials and shingles or panels with no thermochromic materials.

The patterns created can serve a variety of purposes. Some patterns create a message or advertisement when the material is exposed to light. Again, this is illustrated in FIGS. 5a and 5b. This could also be applied to billboards. For example, advertisers of radiator service in the summer months could also advertise anti-freeze in the winter months.

Other patterns could be used to create shading patterns or other aesthetically desired characteristics of the shingle.

At least one embodiment of the invention is a method for reducing energy absorption of a structure utilizing the color changing materials or panels as described in this application. These embodiments comprise the steps of installing one or more panels having at least a portion of the panel's outer surface comprising a thermochromic material onto a structure, and allowing the portions comprising the thermochromic materials to change color when exposed to light.

In some embodiments, it is desirable that the change in color is not readily observable for a person at or near ground level. For instance, some homeowners may not like the appearance of a white roof In such an embodiment, the outer surface of the roof panels can comprise materials in which a visible color change is primarily observed within a specific range of viewing angles. In these embodiments, the panels would change color when exposed to the incident light of the sun; however, because of the viewing angle of a person at or near ground level is outside the range in which a color change would be observed, a person on the ground would not notice the change in color. In some embodiments, observers from the air would be able to discern the color change, depending on the viewing angle. Materials that change color when viewed from different viewing angles are described in U.S. Pat. No. 5,733,976, U.S. Pat. No. 5,824,733, U.S. Pat. No. 6,562,323 and U.S. Pat. No. 5,990,219, which are herein incorporated by reference. By adding thermochromic material to these paints, coatings, and/or material the roof can appear different at one viewing angle, but white and reflective to an observer from above.

Depending on the pitch of the roof, the roof tile or shingle can be manufactured such that the viewing angles which minimize or reduce the observance of a color change is adjusted for that specific pitch. In various embodiments various amounts of color change can be observed depending on the designed angle at which the light is reflected. In FIG. 7 the roof portion 10 has particles 70 or larger materials that have thermochromic material primarily on the top 75 of the particles and non-thermochromic material on the sides 74 (please see FIG. 7c for more detail). From the ground view 71 the color transition of the roof can appear as shown in FIG. 7a while from an upper view 72, and substantially the angle at which sunlight in the summer months incidents the roof, the color transition is visible as shown in FIG. 7b. Though FIG. 7c shows a backward slant to the top surface 75, the backward slant is not necessary in some embodiments. Particles having a rounder appearance as that illustrated in FIG. 3 can also be used. This can also be done on metal woods.

In one embodiment, the method for reducing energy absorption comprises the steps of applying a thermochromic material to at least a portion of the outer surface of one or more installed panels and allowing the portions of the panel comprising the thermochromic material to change color when exposed to light.

At least one embodiment of the invention is a method for displaying an image on a structure or panel utilizing the color changing materials described in this application. These embodiments comprise the steps of installing one or more panels having at least a portion of the panel's outer surface comprising a thermochromic material onto a structure, and allowing the portions comprising the thermochromic materials to change color when exposed to light.

In one embodiment, the method for displaying an image comprises the steps of applying a thermochromic material to at least a portion of the outer surface of one or more installed panels and allowing the portions of the panel comprising the thermochromic material to change color when exposed to light.

A possible claim may read as follows: A method for producing an image or pattern on a building structure comprising the steps of installing one or more shingles from claims 1-17 onto a structure, and allowing the portions comprising the thermochromic materials to change color when exposed to light.

In some embodiments a roof substrate can now require less or no insulation or thermal barriers as the roof having the thermochromic material will not need these layers to the same degree.

The thermochromic material can be combined with a carrier material. It can also be encapsulated with a solvent and optionally a color former in a microcapsule suspended in the carrier material. Suitable carrier material are a wide variety of thermoplastics and polymers.

Thermochromatic materials can be added to thermoplastic polyolefins, ethylene propylene diene Monomer(EPDM), elastomeric materials, natural and synthetic rubber, polyvinyl, and polyolefin materials to create a color changing roof.

Thermochromatic materials can also be added to direct to metal (DTM) coatings to create a color changing roof.

Steel roofs with painted or powder coatings having thermochromatic materials added can be used to create a color changing roof. These powder coatings having thermochromic material can be applied to all the roof and siding surfaces given herein to create a color changing roof.

Some specific roofing products that can have color changing materials and/or thermochromic materials applied or composed in the manufacturing of the surface of the product or throughout the product are Copolymer-Alloy Roofing CPA, Ethylene-Interpolymer Roofing EIP, Polyvinyl-Chloride Roofing PVC, Thermoplastic-Polyolefin Roofing TPO, and Nitrile-Butadiene-Polymer NBP. These can be applied as Single-ply roofing membranes. Single-ply roofing can come in large rolls and can be glued or mechanically fastened to a roof, and sealed at all seams. The three major categories of single-ply membranes are Thermosets, Thermoplastics and Modified Bitumens.

A heteropolymer or copolymer is a polymer derived from two (or more) monomeric species, as opposed to a homopolymer where only one monomer is used.^{[1]} Copolymerization refers to methods used to chemically synthesize a copolymer.

Some commercially used copolymers include ABS plastic, SBR, Nitrile rubber, styrene-acrylonitrile, styrene-isoprene-styrene (SIS) and ethylene-vinyl acetate.

Since a copolymer consists of at least two types of constituent units (also structural units), copolymers can be classified based on how these units are arranged along the chain.^{[2]} These include:
Alternating copolymers with regular alternating A and B units (2)
Periodic copolymers with A and B units arranged in a repeating sequence (e.g. (A-B-A-B-B-A-A-A-A-B-B-B)ₙ)
Statistical Copolymers are copolymers in which the sequence of monomer residues follows a statistical rule. If the probability of finding a given type monomer residue at a particular point in the chain is equal to the mole fraction of that monomer residue in the chain, then the polymer may be referred to as a truly random copolymer^{[3]} (3).
Block copolymers comprise two or more homopolymer subunits linked by covalent bonds (4). The union of the homopolymer subunits may require an intermediate non-repeating subunit, known as a junction block. Block copolymers with two or three distinct blocks are called diblock copolymers and triblock copolymers, respectively.

Copolymers may also be described in terms of the existence of or arrangement of branches in the polymer structure. Linear copolymers consist of a single main chain whereas branched copolymers consist of a single main chain with one or more polymeric side chains.

Other special types of branched copolymers include star copolymers, brush copolymers, and comb copolymers.

A terpolymer is a copolymer consisting of three distinct monomers. The term is derived from ter (Latin), meaning thrice, and polymer.

CPA roof membrane materials can be produced by alloying polymeric plasticizers, stabilizers, biocides and antioxidants with PVC compounds.

Ethylene Interpolymer roofing uses ethylene interpolymer a group of thermoplastic compounds generally based on PVC polymers. It can be applied as a membrane or sheet.

Polyvinyl-Chloride, commonly abbreviated PVC, is a thermoplastic polymer. It is a vinyl polymer constructed of repeating vinyl groups (ethenyls) having one hydrogen replaced by chloride. It can be made softer and more flexible by the addition of plasticizers, the most widely used being phthalates. As such it can act similar to rubber.

TPO is a trade name that refers to polymer/filler blends usually consisting of some fraction of PP (polypropylene), PE (polyethylene), BCPP (block copolymer polypropylene), rubber, and a reinforcing filler. Common fillers include, though are not restricted to talc, fiberglass, carbon fiber, wollastonite, and MOS (Metal Oxy Sulfate). Common rubbers include EPR (Ethylene propylene rubber), EPDM (EP-diene rubber), EO (ethylene-octene), EB (ethylene-butadiene), SEBS (Styrene-ethylene-butadiene-styrene). Currently there is a great variety of commercially available rubbers and BCPP's. They are produced using regioselective and stereoselective catalysts known as metallocenes. The metallocene catalyst becomes embedded in the polymer and cannot be recovered.

The geometry of the metallocene catalyst will determine the sequence of chirality in the chain, as in, atactic, syndiotactic, isotactic, as well as average block length, molecular weight and distribution. These characteristics will in turn govern the microstructure of the blend.

The components are blended together at 210-270° C. under high shear. A twin screw extruder or a continuous mixer may be employed to achieve a continuous stream, or a Banbury compounder may be employed for batch production. A higher degree of mixing and dispersion is achieved in the batch process, but the superheat batch must immediately be processed through an extruder to be pelletized into a transportable intermediate. Thus batch production essentially adds an additional cost step.

As in metal alloys the properties of a TPO product depend greatly upon controlling the size and distribution of the microstructure. PP and PE form a vaguely crystalline structure known as a spherulite. Unlike metals, a spherulite cannot be described in terms of a lattice or unit cell, but rather as a set of polymer chains that pack down closely next to one another and form a dense core. The PP and PE components of a blend constitute the “crystalline phase”, and the rubber gives the “amorphous phase”.

If PP and PE are the dominant component of a TPO blend then the rubber fraction will be dispersed into a continuous matrix of “crystalline” polypropylene. If the fraction of rubber is greater than 40% phase inversion may be possible when the blend cools, resulting in an amorphous continuous phase, and a crystalline dispersed phase. This type of material is non-rigid, and is sometimes called TPR for ThermoPlastic Rubber.

To increase the rigidity of a TPO blend, fillers exploit a surface tension phenomena. By selecting a filler with a higher surface area per weight, we can achieve a higher flexural modulus.

TPO blends can have densities 0.92-1.1

TPO is frequently found in outdoor applications such as roofing because it does not degrade under solar UV radiation, a common problem with nylons. TPO is used extensively in the automotive industry.

TPO is easily processed by injection molding, profile extrusion, and thermoforming. TPO cannot be blown, or sustain a film thickness less than ¼ mil (about 6 micrometres), where 1 mil is equal to 0.001 inch.

NBR is a synthetic rubber copolymer of acrylonitrile (ACN) and butadiene.

Nitrile butadiene rubber (NBR) is a family of unsaturated copolymers of 2-propenenitrile and various butadiene monomers (1,2-butadiene and 1,3-butadiene). Although its physical and chemical properties vary depending on the polymer's composition of nitrile, this form of synthetic rubber is generally resistant to oil, fuel, and other chemicals (the more nitrile within the polymer, the higher the resistance to oils but the lower the flexibility of the material).

NBR's ability to withstand a range of temperatures from −40° C. to +108° C. makes it an ideal material for roofing and exterior surfaces in extreme condition.

Nitrile rubber is generally resistant to aliphatic hydrocarbons. Nitrile, like natural rubber, can be attacked by ozone, aromatic hydrocarbons, ketones, esters and aldehydes.

EPDM is a type of synthetic rubber, is an elastomer which is characterized by a wide range of applications. The E refers to Ethylene, P to Propylene, D to diene and M refers to its classification in ASTM standard D-1418. The “M” class includes rubbers having a saturated chain of the polymethylene type. The diene(s) currently used in the manufacture of EPDM rubbers are DCPD (dicyclopentadiene), ENB (ethylidene norbornene) and VNB (vinyl norbornene). The ethylene content is around 45% to 75%. The higher the ethylene content the higher the loading possibilities of the polymer, better mixing and extrusion. Peroxide curing these polymers give a higher crosslink density compared with their amorphous counterpart. The amorphous polymer are also excellent in processing. This is very much influenced by their molecular structure. The dienes, typically comprising between 2.5 wt % up to 12 wt % of the composition serve as crosslinks when curing with sulphur and resin, with peroxide cures the diene (or third monomer) functions as a coagent, which provide resistance to unwanted tackiness, creep or flow during end use.

EPDM can also be used as a covering to waterproof roofs. It has the benefit that it does not pollute the runoff rainwater, which is of vital importance if the house owner wishes to use this water for personal sanitation/hygiene. Several houses equipped with rainwater harvesting thus make use of this type of roofing.

Thermoplastic polymers that can have thermochromic material added include polyolefins, e.g. polyethylene, polypropylene, polybutylene, and copolymers thereof, polytetrafluoroethylene, polyesters, e.g. polyethylene terephthalate, polyvinyl acetate, polyvinyl chloride acetate, polyvinyl butyral, acrylic resins, e.g. polyacrylate, and polymethylacrylate, polymethylmethacrylate, polyamides, namely nylon, polyvinyl chloride, polyvinylidene chloride, polystyrene, polyvinyl alcohol, polyurethanes, cellulosic resins, namely cellulosic nitrate, cellulosic acetate, cellulosic acetate butyrate, ethyl cellulose, etc., copolymers of any of the above materials, e.g. ethylene-vinyl acetate copolymers, ethylene-acrylic acid copolymers, styrene-butadiene block copolymers, Kraton rubbers and the like.

Thermoplastic fibers include, but are not limited to, polyester fibers, polyamide fibers, polypropylene fibers, copolyetherester fibers, polyethylene terephthalate fibers, polybutylene terephthalate fibers, polyetherketoneketone (PEKK) fibers, polyetheretherketone (PEEK) fibers, liquid crystalline polymer (LCP) fibers, and mixtures thereof. Polyamide fibers include, but are not limited to, nylon 6, 66, 11, 12, 612, and high temperature “nylons” (such as nylon 46) including cellulosic fibers, polyvinyl acetate, polyvinyl alcohol fibers (including various hydrolysis of polyvinyl alcohol such as 88% hydrolyzed, 95% hydrolyzed, 98% hydrolyzed and 99.5% hydrolyzed polymers), cotton, viscose rayon, thermoplastic such as polyester, polypropylene, polyethylene, etc., polyvinyl acetate, polylactic acid, and other common fiber types. The thermoplastic fibers are generally fine (about 0.5-20 denier diameter), short (about 0.1-5 cm long), staple fibers, possibly containing precompounded conventional additives, such as antioxidant, stabilizers, lubricants, tougheners, etc. In addition, the thermoplastic fibers may be surface treated with a dispersing aid.

Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Preferred addition polymers tend to be glassy (a Tg greater than room temperature). This is the case for polyvinylchloride and polymethylmethacrylate, polystyrene polymer compositions or alloys or low in crystallinity for polyvinylidene fluoride and polyvinylalcohol materials. One class of polyamide condensation polymers are nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Another nylon can be made by the polycondensation of epsilon caprolactam in the presence of a small amount of water. This reaction forms a nylon-6 (made from a cyclic lactam—also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C₁₀ blend of diacids. A nylon 6-6,6-6,10 is a nylon manufactured by copolymerization of epsilonaminocaproic acid, hexamethylene diamine and a blend of a C₆ and a C₁₀ diacid material.

Block copolymers are also useful in the process of this invention. One example is a ABA (styrene-EP-styrene) or AB (styrene-EP) polymer Examples of such block copolymers are Kraton® type of styrene-b-butadiene and styrene-b-hydrogenated butadiene(ethylene propylene), Pebax® type of e-caprolactam-b-ethylene oxide, Sympatex® polyester-b-ethylene oxide and polyurethanes of ethylene oxide and isocyanates.

In all of the examples and applications disclosed in this application, unless otherwise indicated differently, all the roofing systems can have areas that do not change color under changing conditions, areas that change at a lower threshold or different threshold, and areas that change at different thresholds. Such an invention can create very unique roofs and siding.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A shingle having a color changing outer surface, the color changing outer surface having a first color under a first environmental condition and a second color under a second environmental condition, the color changing outer surface capable of both changing from the first color to the second color and from the second color to the first color.

2. The shingle of claim 1 wherein the outer surface comprises discrete particles.

3. The shingle of claim 1 wherein the shingle comprises asphalt.

4. The shingle of claim 1 wherein the outer surface includes (a) one or more electron-donating, chromatic organic compounds selected from the group consisting of diaryl phthalides, aryl phthalides, indolylphthalides, polyarylcarbinols, leucoauramines, acrylauramines, arylauramines, rhodamine B lactams, indolines, spiropyrans, fluorans, thiofluorans, phenothiazines, triphenylmethanes, diarylarylfurans, spiroxanthenearylfurans, and chromenoindoles, (b) one or more compounds capable of reversibly accepting electrons of said organic compound selected from the group consisting of phenolic hydroxy group-containing compounds and derivatives thereof and carboxyl group-containing compounds and derivatives thereof, (c) one or more compounds controlling the temperature and sensitivity of coloration/decoloration of said thermochromic material selected from the group consisting of alcohols, esters, ketones, esters, acid amides and carboxylic acids, the ratio of each component to others (a):(b):(c) being 1:0.1 to 10:1 to 100 by weight, and (d) one or more radical cationic compounds selected from the group consisting of N-radical cationic, P-radical cationic, O-radical cationic and S-radical cationic compounds having aromatic ring(s), in an amount of from 0.01 to 5 parts by weight per 1 part by weight of said electron-donating chromatic organic compound, said radical cationic compound interacting with said electron-donating, chromatic organic compound to stabilize said compound, resulting in a thermochromic material with an improved resistance to light.

5. The shingle of claim 1 wherein the outer surface comprises asphalt.

6. The shingle of claim 1 wherein a transparent layer is disposed over the outer surface.

7. A shingle having a color changing outer surface having a first color under a first environmental condition and a second color under a second environmental condition, the color changing outer surface capable of both changing from the first color to the second color and from the second color to the first color, the shingles being selected from the group consisting of asphalt, wood, metal, and concrete, the shingle further comprising particles that are individually color changing.

8. The shingle of claim 7 wherein both the first environmental condition and the second environmental condition are selected from the group consisting of temperature, light level, wavelength of light, and any combination thereof

9. The shingle of claim 7 wherein the color changing outer surface is covered by a layer of transparent material.

10. The shingle of claim 7 wherein the outer surface comprises a particle comprising a thermochromic coating.

11. The shingle of claim 7 wherein the outer layer is a laminate comprising thermochromic material.

12. The shingle of claim 7 having a transition from the first color to the second color that occurs at a threshold temperature.

13. The shingle of claim 7 having a gradual transition from the first color to the second color with a rise in temperature.

14. The shingle of claim 7 wherein the outer surface comprises (a) one or more electron-donating, chromatic organic compounds selected from the group consisting of diaryl phthalides, aryl phthalides, indolylphthalides, polyarylcarbinols, leucoauramines, acrylauramines, arylauramines, rhodamine B lactams, indolines, spiropyrans, fluorans, thiofluorans, phenothiazines, triphenylmethanes, diarylarylfurans, spiroxanthenearylfurans, and chromenoindoles, (b) one or more compounds capable of reversibly accepting electrons of said organic compound selected from the group consisting of phenolic hydroxy group-containing compounds and derivatives thereof and carboxyl group-containing compounds and derivatives thereof, (c) one or more compounds controlling the temperature and sensitivity of coloration/decoloration of said thermochromic material selected from the group consisting of alcohols, esters, ketones, esters, acid amides and carboxylic acids, the ratio of each component to others (a):(b):(c) being 1:0.1 to 10:1 to 100 by weight, and (d) one or more radical cationic compounds selected from the group consisting of N-radical cationic, P-radical cationic, O-radical cationic and S-radical cationic compounds having aromatic ring(s), in an amount of from 0.01 to 5 parts by weight per 1 part by weight of said electron-donating chromatic organic compound, said radical cationic compound interacting with said electron-donating, chromatic organic compound to stabilize said compound, resulting in a thermochromic material with an improved resistance to light.

15. The shingle of claim 7 wherein the outer surface is a coating, the coating selected from the group consisting of powder coatings, paint, polymer, and any combination thereof.

16. The shingle of claim 15 wherein the coating is a powder coating selected from the material group consisting of epoxies, polyesters, urethanes, nylon, vinyl, polyethylene, and any combination thereof

17. The shingle of claim 7 wherein the outer surface coating is of uniform construction.

18. A roof comprising a plurality of shingles from claim 1.

19. The roof from claim 18 wherein at least one portion of the roof maintains the substantially same color under the first environmental condition and the second environmental condition.

20. A method for reducing energy absorption in a building structure comprising the steps of installing one or more shingles onto a structure, and allowing the portions comprising the thermochromic materials to change color when exposed to light, the one or more shingles having a color changing outer surface, the color changing outer surface having a first color under a first environmental condition and a second color under a second environmental condition, the color changing outer surface capable of both changing from the first color to the second color and from the second color to the first color.
